(19) United States
(12) Patent Application Publication
(10) Pub. No.: US 2012/0126008 A1
(43) Pub. Date: May 24, 2012

(54) THIN MOUNT RFID TAGGING SYSTEMS

(75) Inventor: Ian Rex Binmore, Houston, TX (US)

(73) Assignee: Merrick Systems Inc., Houston, TX (US)

(21) Appl. No.: 12/953,289

(22) Filed: Nov. 23, 2010

(51) Int. Cl. G06K 19/067; B32B 37/12; G06K 7/00

(52) U.S. Cl. 235/439; 235/492; 156/280

(57) ABSTRACT

A tag, such as an RFID tag, a system including the RFID tag and techniques for installing the RFID tag onto the surface of a tool. The RFID tag is coupled to an outer surface of a tool via an adhesive and/or coating that acts to retain the tag. The RFID tag is coated with a thin protective coating or casing material that may be disposed about a circumference of the RFID tag.

### BACKGROUND

1. Field of Invention

Embodiments of the invention relate generally to identification tags, and more specifically, to Radio-frequency identification (RFID) tags configured for usage in thin-walled pipe applications. Examples include oilfield casing, production tubing, liner and other equipment where tags are advantageously installed onto the surface of materials and still survive severe use environments.

2. Description of Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light and not as admissions of prior art.

Identification of assets may be critical in the management and tracking of objects, such as system components, tools, machinery, equipment, etc., through production, inventory, storage, deployment and/or product use. In certain applications, manual identification, by stamping, branding, or etching and identification number into an asset to be tracked may be acceptable. However, manual identification may be labor intensive for users trying to track individual tools or system components by visual identification. Further, when equipment or system components are in storage, the components may be stacked or stored such that visual identification is difficult. This may also be true when the system components are in field use or when optically read identifiers become dirty or worn. In addition, for equipment and tools that are to be used in rugged environments, such as those used in oil and gas applications, manual tags, such as brands or stamps may be sheared, scraped or otherwise damaged thereby rendering the identification of such equipment by serial number very difficult.

Electronic tagging of equipment may simplify tracking, compared to manual tagging and visual tracking. Identification tags, such as RFID tags are often used to manage and track objects, such as system components, tools, machinery, equipment, etc., through production, inventory, storage, deployment and/or product use. In general, RFID tags include a microchip or integrated circuit used to transmit and/or store identification information for tracking purposes. An external transceiver/interrogator/reader located in close proximity or remotely with respect to the RFID tag is used to receive information from and/or transmit information to the RFID tag. The RFID tag typically includes an antenna that transmits RF signals relating to the identification and/or information stored within the RFID tag.

For certain applications, such as surface and downhole oil and gas applications, RFID tags may be utilized to track equipment and inventory. However, certain types of oil and gas related equipment may offer a number of challenges that must be considered when employing electronic tracking techniques. For instance while attaching external RFID tags to certain equipment may be sufficient for tracking, the mechanical stresses experienced by typical oil and gas equipment during fabrication, storage and field application may damage external RFID tags rendering the external tags inoperable. That is, tags may be crushed or disengaged from equipment during handling.

One potential means of electronically tagging equipment for tracking purposes is to embed an RFID tag into a pocket drilled or otherwise formed in the equipment. However, for certain components, this type of tagging may not be desirable. For instance, oil country tubular goods (OCTG), including tubing, casing, and liner, may be too thin or structurally inappropriate to allow for drilling a pocket and mounting a tag into the parent material. Further, an RFID tag embedded into certain types of equipment may experience interference if the RFID tag is embedded too far within the tool.

It may be desirable to design an optimized RFID tagging system that is particularly well-suited for OCTG equipment and other components having thin walls or requiring a durable surface mount configuration.

### BRIEF DESCRIPTION OF DRAWINGS

Certain embodiments are described in the following detailed description and in reference to the drawings in which:

FIG. 1 illustrates a schematic view of an RFID tag system including an RFID tag and a reader, in accordance with embodiments of the invention;

FIG. 2 illustrates a schematic view of the RFID tag of FIG. 1 coupled to a pipe and having a protective casing material dispensed thereon, in accordance with embodiments of the invention;

FIG. 3 illustrates a schematic view of the RFID tag of FIG. 2 coupled to a pipe after the protective casing material has been dispensed thereon, in accordance with embodiments of the invention; and

FIG. 4 is a flow chart illustrating the method of FIGS. 2 and 3, in accordance with first embodiments of the invention.

### DETAILED DESCRIPTION

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Generally, embodiments of the invention are directed to an identification system including an identification tag, such as an RFID tag, configured to be attached to an object. In certain embodiments, the object may include a structure such as a pipe, riser, flange, weldment, casting, or any material, equipment or tool used the oil and gas industry. In accordance with embodiments of the present invention, the disclosed techniques are particularly useful for tools and equipment that are relatively thin or otherwise susceptible to structural degradation if the housing of the tool or equipment is compromised. Accordingly, rather than embedding an RFID tag into the tool or object by creating a pocket to house the RFID tag within a surface of the object and thereby breaching the integrity of the object, an RFID tag is adhered to the outside of the tool or object. Advantageously, the RFID tag is thin and flexible such that it conforms to the shape of the tool or object to which it is attached (e.g., a pipe or other oil country tubular goods (OCTG)). In other words, the RFID tag is said to be “conformal.” After the RFID tag is attached to the tool or object, a protective casing material is applied over the RFID tag to uniformly encase the RFID tag. Where multiple frequency RFID capability is required, or tag redundancy is desired, multiple tags can be applied to the parent material and all encased within the protective material coating the equipment and electronics module(s). In the usage of a pipe or other OCTG, the protective casing material may be applied such that it creates an annular ring about the pipe. The protective casing material is selected such that it is easily applied to the pipe and such that it provides a thin coating that protects the underlying RFID tag from mechanical and environmental stress, without significantly increasing the thickness of the pipe (i.e., circumferentially). In accordance with the embodiments described herein, the casing material is an improvement on prior systems in that it provides protection to a surface-mounted RFID tag that can absorb handling forces such as impact without shattering or breakage, is resistant to oil industry chemicals and materials, will not interfere with existing handling methods for casing and tubing and is economical to apply in a production environment as it does not require long cure cycles, exotic materials or complex application processes, as described further below.

In certain applications, the RFID tag may be most useful in tracking equipment and tools while they are stored as inventory, or during surface-based inspection, handling and use and/or shallow depth oil well applications. In other embodiments, the RFID tag and protective casing material may be selected for usage in high temperature and/or high pressure environments and may advantageously provide readability, easy installation, and packaging that is resistant to mechanical and chemical stresses, even in harsh conditions. Depending on the application and the materials used to fabricate the RFID tag and the protective casing material, the RFID tag may be suited for downhole drilling and subsea, mining or industrial equipment.

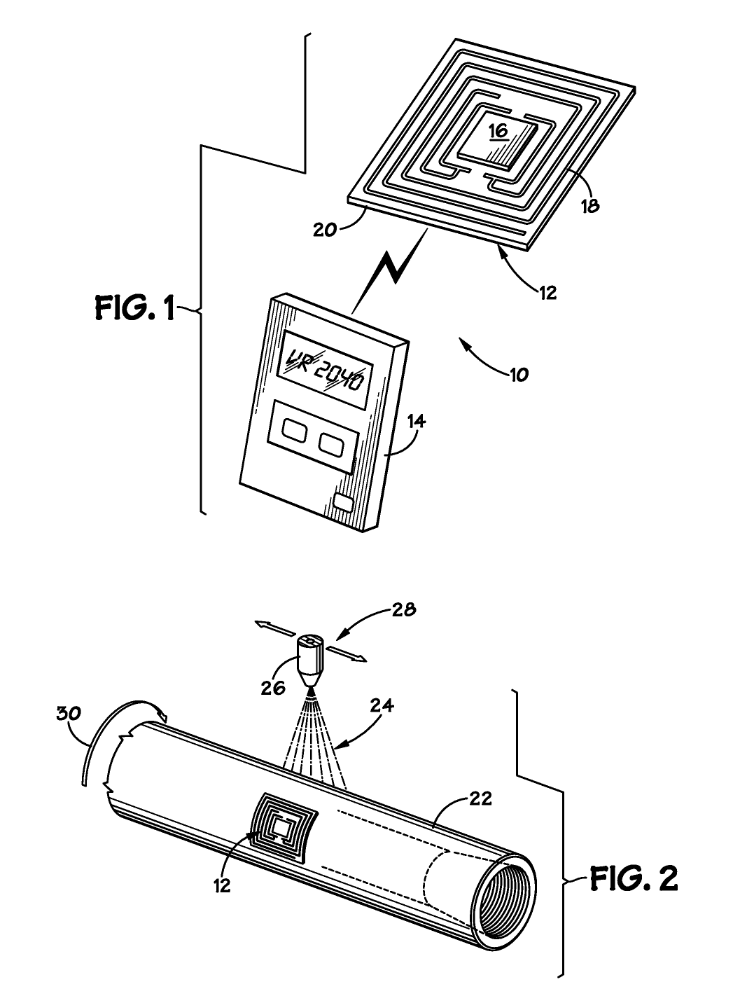

Turning now to the drawings, and referring initially to FIG. 1, an RFID tag system 10 is illustrated. Specifically, the RFID tag system 10 includes an RFID tag 12 and a reader 14. It should be appreciated that multiple RFID tags 12 may be included in the RFID tag system 10, to be read by the reader 14. As will be described further below, utilizing multiple RFID tags 12 may be beneficial to provide a number of angles from which the reader 14 may interrogate the RFID tags 12. In addition, utilizing multiple RFID tags 12 provides redundancy in the event that one or more of the RFID tags 12 is damaged. The reader 14 is generally configured to interrogate the RFID tag 12. Accordingly, the reader 14 typically includes a transmitter and receiver for exchanging RFID information with the RFID tag 12. The reader 14 may also include a processor for receiving the RF data from the RFID tag 12 and extrapolating the RF data into meaningful data whereby identification or other fixed or stored information can be perceived by a user. In certain embodiments, the reader 14 may be integrated with a computer system.

As used herein the term “RFID tag” refers to an identification and reporting device that uses electronic tags for identifying and/or tracking articles to which the RFID tag may be attached. As will be appreciated, the RFID tag 12 typically includes at least two components. The first component is an integrated circuit (IC) chip 16, for processing information and modulating and demodulating a radio frequency signal. The IC chip 16 may include a memory chip for storing manufacturing, user, calibration and/or other data stored thereon. One embodiment of the invention uses an integrated circuit device that may also include RF signal modulation circuitry fabricated using a complementary metal-oxide semiconductor (CMOS) process and a non-volatile memory. The RF signal modulation circuitry components may include a diode rectifier, a power supply voltage control, a modulator, a demodulator, a clock generator, and other components. Each RFID tag 12 also includes an antenna 18 for transmitting and receiving radio frequency signals.

The IC chip 16 and antenna 18 are coupled to a substrate 20. In accordance with embodiments of the invention, the substrate 20 is generally thin and flexible to allow deformation about an object to be tagged (e.g., a pipe), such that the RFID tag(s) 12 generally conforms to the shape of the object. For instance, the substrate 20 may comprise any suitable material, such as polyethylene terepthalate (PET), polycarbonate (e.g., LEXAN), polymer material (e.g., MYLAR), polyester, or metal foil, for example. Further, the substrate 20, or the thickness of the RFID tag 12, may be in the range of approximately 10-100 mil.

The RFID tag(s) 12 may be passive, active, or semi-active or a suitable combination for the desired application. Passive RFID tags rely on the reader 14 to provide the power source for activation. While passive RFID tags 12 may be employed for certain applications, active or semi-active RFID tags 12 may be more suitable for applications where the reader 14 is located beyond the range of ability of the RFID tag 12 to passively communicate with a reader 14. If the RFID tag 12 is active or semi-active, the RFID tag 12 may include a battery (not shown) for transmission of RF signals.

As will be appreciated, while an RFID tag system 10 including an RFID tag 12 is illustrated and described below, embodiments of the invention may utilize other types of identification tags, which utilize other types of wireless technology, such as Sonic Acoustic Wave (SAW), ultra low frequency, high frequency or ultra high frequency, or systems or combinations of frequency that are used for powering, interrogating or reading, writing or accessing information or identities stored within an electronics module contained in a manner expressed herein. The RFID tags 12 may also have RFID net capability where one tag can communicate with a reader via another tag in the read path. That is, while the exemplary embodiments describe using RF technology to provide identification of the tagged components, the packaging configurations described below may also be used to encase other types of thin identification and data storage modules. Still further, while identification modules are described, one skilled in the art would appreciate that any electronics module or sensor that may be desired for a particular application, may be packaged as described.

Referring now to FIG. 2, a schematic depiction of a technique for attaching an RFID tag 12 to an object or tool, in accordance with embodiments of the present invention, is illustrated. Specifically, the RFID tag 12 is attached to an OTCG, such as a pipe 22. As previously described, the RFID tag 12 is flexible, such that it conforms to the shape of the pipe 22. After preparing the surface of the pipe 22, as described further with reference to FIG. 4, an adhesive may be used to affix the RFID tag 12 to the surface of the pipe 22. The adhesive may be applied to the surface of the pipe 22, or the backside of the RFID tag 12. In one embodiment, the adhesive may be Chemlok 213® adhesive or other such suitable adhesive dependent upon the backing material used for the RFID tag 12. Alternatively, the tag may be adhered with the primer used to improve the metal to coating bond, or the RFID tag 12 may be fabricated with an adhesive backing that may be used to affix the RFID tag 12 to the pipe 22. As previously described, additional RFID tags 12 may also be attached to the pipe 22.

After the RFID tag 12 is attached to the surface of the pipe 22, a primer/adhesive material may be applied to the metal pipe 22 to provide a stronger bond for the protective casing material to the metal. In one embodiment, Lord Chemlok 213® provides the bonding enhancement appropriate for a protective casing material, such as urethane. The material can be brushed, rolled or sprayed onto clean pipe 22, such as a steel pipe, prior to coating. The protective casing material 24 may then be used to coat the RFID tag 12. In one embodiment, the protective casing material 24 comprises a urethane coating that may be applied using a spray dispenser 26. That is, the casing material 24 may be provided in a two part liquid form consisting of BASF ElastoCast™ 55090R Resin and BASF ElastoCast™ S55090T Isocyanate applied through a mixing machine such as the Gusmer H-2035 such that it may be sprayed as a thin coating over the RFID tag 12 and pipe 22 with a spray system similar to that used for automotive spray painting. In the illustrated embodiment, the spray dispenser 26 may be laterally moved back-and-forth parallel to the length of the pipe 22, as illustrated by direction arrow 28, while the pipe 22 is rotated about its central axis, as illustrated by the rotational arrow 30. As will be appreciated, any suitable means for disposing a relatively uniform thin layer of protective casing material 24 may be utilized. For instance, with proper selection of material, the protective casing material 24 may be disposed using brushes, sponges or pads. Regardless of the selected means for disposing the protective casing material 24, the protective casing material 24 may be disposed to a relatively uniform thickness in the range of 10-120 mil. The protective casing material 24 is deposited for such a time as to sufficiently cover the underlying RFID tag 12. The thickness of the coverage will vary depending on the application. A thicker covering will provide more impact resistance and protection to the RFID tag 12, while a thinner covering will be less likely to be sheared when OCTG pipe 22 is run into a well. In certain embodiments, the thickness may be in the range of about 30-80 mil.

While a urethane coating may be used for the protective casing material 24, other materials may also be suitable. For instance, Nitrile, Viton, and other suitable elastomers that have a history of use in a downhole environment may be utilized. These materials are applicable to downhole use on production tubing and other items that need to be recovered after years of downhole use and identified for inspection and re-use.

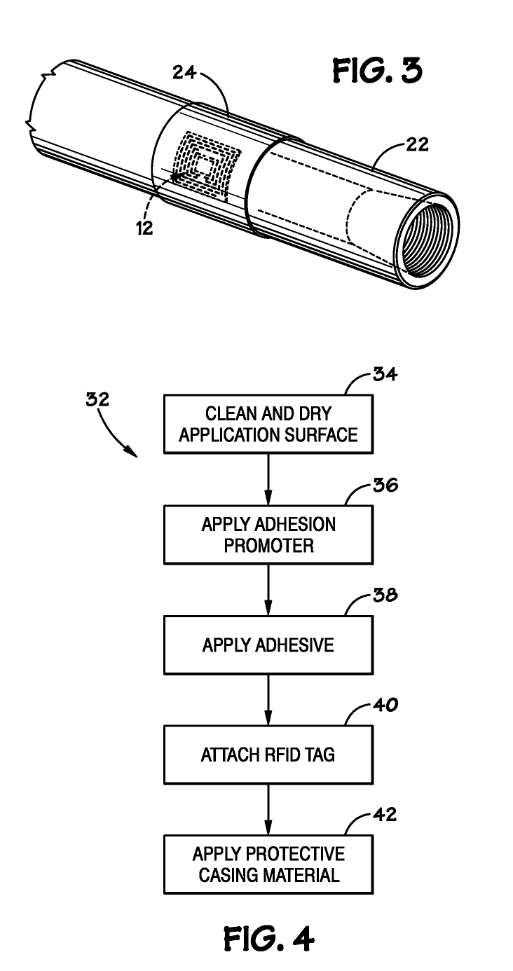

FIG. 3 illustrates one embodiment of the pipe 22, wherein the protective casing material 24 has been disposed over the RFID tag 12. In the illustrated embodiment, the protective casing material 24 is disposed such that it creates an annular ring about the pipe 22. By coating the protective casing material 24 to circumvent the pipe 22, the protective casing material 24 provides a uniform structure about the pipe 22. The annular deposition of the coating may be advantageous in that the coated pipe 22 is still uniform on all sides. Further, in certain embodiments, it may be advantageous to taper the deposition of the protective casing material 24 such that it is thickest about the circumference of the pipe directly covering the RFID tag 12 and tapers out at the ends of the band of application. By disposing the protective casing material 24 to be thickest over the RFID tag 12 and tapered at the end, maximum protection is provided along with ease of running the pipe into a tight annulus or past a protrusion. By maintaining the thickness about the circumference of the pipe 22 in the region wherein the underlying RFID tag 12 is attached, the protective casing material 24 is uniform on all sides of the pipe 22. However, in certain embodiments, the protective casing material 24 may be disposed such that it is thinner further from the circumferential center of the RFID tag 12. In other words, the thickness of the protective casing material 24 is gradually decreased away from the RFID tag 12. Despite the graduated thickness of the protective casing material 24 in this embodiment, the thickness of the protective casing material 24 is relatively uniform about the entire circumference of the pipe 22 at any particular position.

As previously described, additional RFID tags 12 (not illustrated) may be employed. In certain embodiments, additional RFID tags 12 may be attached to the pipe 22 at approximately the same longitudinal location along the pipe 22, but at a different circumferential location than the illustrated RFID tag 12. For instance, an additional RFID tag 12 may be disposed opposite the illustrated RFID tag 12 (i.e., approximately 180 degrees from the illustrated RFID tag 12, about the circumference of the pipe 22) to provide redundancy or enhanced readability. Advantageously, by positioning additional RFID tags 12 about the pipe 22 at approximately the same longitudinal position, each of the RFID tags 12 can be covered by the protective casing material 24 during the same application process.

FIG. 4 is an exemplary process 32 for attaching an RFID tag 12 to a tool, such as the pipe 22, and coating the RFID tag 12 with the protective casing material 24, in accordance with embodiments of the invention described above. First, the surface of the object may be cleaned and dried to maximize the adhesion of the RFID tag 12 and coating to the surface, as indicated in block 34. The surface may be cleaned with any suitable cleaning agent. Alternatively, or in addition, the surface may receive mechanical treatment, such as buffing, to further promote successful adhesion. Optionally, after cleaning and drying, an adhesion promoter may be applied to the surface, as indicated in block 36. Suitable adhesion promoters may include, but are not limited to Lord Chemlok 213® which can be used to adhere the tag and at the same time prime the base metal material for the final urethane coating. Optionally, a separate adhesive may be applied, as indicated in block 38. As previously described, the adhesive may be applied to the prepared surface, or to the backside of the RFID tag 12. As previously described, in certain embodiments, the RFID tag 12 may include an adhesive surface, whereby a backing is peeled from the backside of the RFID tag 12, or the backside of the RFID tag 12 is exposed to water to activate the adhesive. If such RFID tags are used, application of the adhesive may be omitted. Next, the RFID tag 12 is brought into contact with the surface of the object (e.g., pipe 22) to attach the RFID tag 12 to the object, as indicated in block 40. Pressure may be applied to the front surface of the RFID tag 12 to ensure a secure coupling by the underlying adhesive. Finally, the protective casing material 24 may be applied over the RFID tag 12 and onto the surface of the object, as described above and indicated in block 42.

As will be appreciated, the tagging system described herein provides a number of advantages and may be particularly useful for tagging tools and equipment for tracking during inventory storage, shipping and field operations including field automaton. These advantages may be particularly evident in OCTG components and other tools and equipment having relatively thin walls that are susceptible to structural degradation if the surface of the tool or equipment is impacted or breached (e.g., by forming a tag pocket in which an RFID tag may be deposited). Breaches in such thin or delicate surfaces may create stress pockets susceptible to buckling, bending, axial loading or other maladies that may cause failure of the item. By using the techniques provided herein, a thin RFID tag may be adhered to the surface of the tool, such that the surface of the tool is not breached. Further, by selecting a thin RFID tag that is flexible and can conform to the shape of the tool, the likelihood that the RFID tag will be dislodged, is reduced compared to bulkier RFID tags and/RFID tags that do not conform about a curved surface. By using elastomers as a coating material over the RFID electronics, instead of metal mountings, corrosion and material caused stresses are eliminated. With appropriate material selection as described above, brittleness and risk of subsequent lost identifiers is eliminated. By using a complete coating around pipe, redundant electronics or different electronics may be applied as needed on materials.

In addition, by providing a thin protective coating on top of the RFID tag, the RFID tag is protected from mechanical impact and environmental exposure. The particular material employed for the protective casing material may be selected to enhance protection against predicted exposures. Because the thickness of the protective casing material is relatively thin, the size of the tool or equipment (e.g., pipe) is not substantially increased which reduces design impact on the system in which the tool or equipment will be utilized or stored. Providing a means for coupling an RFID tag to a tool without significantly increasing the size of the tool, as with the embodiments provided herein, may be particularly beneficial in applications where sizing is critical, space is at a premium or where changes in size of the tagged object may effect design of the system or other components of the system. Because there are no breaches introduced into the surface of the tool (e.g., a tag pocket), the equipment is unlikely to be affected by application of the protective casing material (i.e., there are no openings into which the protective casing material could ingress and further effect structural integrity through corrosion, etc.). Further, if a spray-on application process is used to apply the protective casing material, the application process is not labor intensive or time consuming and the process can be automated on a high volume pipe production line. In addition, the RFID tags can be applied in the field at any time. Other advantages of the various aspects of the disclosed techniques are described above, with reference to the figures.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A system comprising:
a tool;
an identification tag coupled to an outer surface of the tool; and
a protective casing material disposed over the identification tag, wherein a thickness of the protective casing material is less than 200 mil.

2. The system, as set forth in claim 1, wherein the tool comprises an oil country tubular good (OCTG).

3. The system, as set forth in claim 1, wherein the tool comprises a pipe or tube.

4. The system, as set forth in claim 1, wherein the identification tag comprises a radio frequency identification (RFID) tag.

5. The system, as set forth in claim 1, wherein the identification tag comprises a flexible substrate configured to conform to the outer surface of the tool.

6. The system, as set forth in claim 1, wherein the identification tag comprises a thickness in the range of approximately 10-120 mil.

7. The system, as set forth in claim 1, wherein the protective casing material comprises urethane.

8. The system, as set forth in claim 1, wherein the protective casing material is configured to be applied to the outer surface of the tool via a spray process.

9. The system, as set forth in claim 1, wherein the protective casing material is disposed about an entire circumference of the tool.

10. The system, as set forth in claim 9, wherein a thickness of the protective casing material is approximately the same, at any point about a single linear circumference about the tool, compared to any other point about the single linear circumference.

11. The system, as set forth in claim 1, wherein a thickness of the protective casing material is greatest directly over the identification tag.

12. The system, as set forth in claim 11, wherein the thickness of the protective casing material gradually diminishes from the identification tag outward along a length of the tool.

13. The system, as set forth in claim 1, comprising a reader configured to receive and/or transmit information to and from the identification tag.

14. The system, as set forth in claim 1, comprising a second identification tag coupled to the outer surface of the tool.

15. The system, as set forth in claim 15, wherein the tool comprises a pipe or tube having a circumference, and wherein each of the identification tag and the second identification tag is coupled to the tool at a different point about the circumference.

16. A method, comprising:
coupling a conformal identification tag to an outer surface of a tool; and
disposing a protective casing material to encase the identification tag against the tool, wherein the protective casing material comprises an elastomer or thermoplastic material.

17. The method, as set forth in claim 16, wherein coupling comprises coupling the conformal identification tag to the outer surface of the tool via an adhesive.

18. The method, as set forth in claim 17, wherein coupling comprises:
applying the adhesive to the outer surface of the tool or a backside of the conformal identification tag; and
applying pressure to a front side of the conformal identification tag to secure the conformal identification tag to the outer surface of the tool, via the adhesive.

19. The method, as set forth in claim 16, wherein coupling the conformal identification tag comprises coupling a radio frequency identification (RFID) tag.

20. The method, as set forth in claim 16, wherein coupling comprises coupling the conformal identification tag to an outer surface of a pipe.

21. The method, as set forth in claim 16, wherein disposing the protective casing material comprises disposing urethane.

22. The method, as set forth in claim 16, wherein disposing comprises spraying the protective casing material over the conformal identification tag and the outer surface of the tool.

23. The method, as set forth in claim 16, wherein disposing comprises forming an annular ring of protective casing material about a circumference of the tool.

24. The method, as set forth in claim 16, wherein disposing comprises disposing the protective casing material at a thickness of less than or equal to approximately 120 mil.

25. The method, as set forth in claim 16, comprising preparing the outer surface of the tool before coupling the conformal identification tag.

26. The method, as set forth in claim 25, wherein preparing comprises cleaning the outer surface of the tool.

27. The method, as set forth in claim 25, wherein preparing comprises applying an adhesion promoter to the outer surface of the tool.

28. A method, comprising:
obtaining a tool having a conformal identification tag coupled to an outer surface of the tool, wherein the conformal identification tag is coated with a protective casing material, wherein the protective casing material comprises an elastomer or thermoplastic material; and
receiving, at a reader, a signal from the conformal identification tag.

29. The method, as set forth in claim 28, wherein a total thickness of the conformal identification tag and the protective casing material coated thereon is less than approximately 200 mil.

30. The method, as set forth in claim 28, wherein obtaining the tool comprises receiving the tool at a warehouse.

31. The method, as set forth in claim 28, wherein obtaining the tool comprises obtaining a pipe.

32. The method, as set forth in claim 28, wherein receiving the signal comprises receiving a radio frequency (RF) signal.

33. The method, as set forth in claim 28, wherein receiving the signal comprises receiving information identifying the conformal identification tag.

34. The method, as set forth in claim 33, wherein the information comprises a serial number.
